(19) United States
(12) Patent Application Publication
(10) Pub. No.: US 2024/0392404 A1
(43) Pub. Date: Nov. 28, 2024

(54) ULTRA-HIGH STRENGTH SPRING STEEL AND PREPARATION METHOD THEREOF

(71) Applicants: SHANDONG JIANZHU UNIVERSITY, Jinan (CN); SHANDONG LIANMEI SPRING CO., LTD, Zibo (CN)

(72) Inventors: Simon Yisheng Feng, Jinan (CN); Rongfu Xu, Jinan (CN); Gang Sun, Zibo (CN); Yunshan Zhang, Zibo (CN)

(21) Appl. No.: 18/616,116

(22) Filed: Mar. 25, 2024

Related U.S. Application Data
(63) Continuation of application No. PCT/CN23/96184, filed on May 25, 2023.

(30) Foreign Application Priority Data
May 23, 2023 (CN) 202310583654.0

(51) Int. Cl. C21D 9/02; B22D 11/00; C21C 7/10; C21D 1/18; C21D 1/84; C21D 6/00; C21D 8/00; C22C 38/00; C22C 38/02; C22C 38/06; C22C 38/22; C22C 38/24; C22C 38/26; C22C 38/38

(52) U.S. Cl. CPC C21D 9/02; B22D 11/001; C21C 7/10; C21D 1/18; C21D 1/84; C21D 6/002; C21D 6/005; C21D 6/008; C21D 8/005; C22C 38/001; C22C 38/02; C22C 38/06; C22C 38/22; C22C 38/24; C22C 38/26; C22C 38/38; C21D 2211/005; C21D 2211/008

(57) ABSTRACT

An ultra-high strength spring steel including chemical components as follows: 0.45 to 0.5% of C, 0.15 to 0.35% of Si, 6.0 to 12.0% of Mn, 1.0-3.0% of Al, 0.30 to 0.50% of Cr, 0.10 to 0.25% of Mo, 0.10 to 0.50% of V, 0.025 to 0.04% of Nb, 0.005 to 0.015% of N, less than or equal to 0.03% of Pb, less than or equal to 0.03% of Sn, less than or equal to 0.03% of Zn, less than or equal to 0.03% of Sb, less than or equal to 0.03% of Bi, less than or equal to 15 ppm of O₂, less than or equal to 15 ppm of H₂, less than or equal to 0.02% of S, less than or equal to 0.02% of P, less than or equal to 0.2% of Cu, less than or equal to 0.35% of Ni, the balance is iron and inevitable impurities.

### CROSS-REFERENCE TO RELATED APPLICATIONS

The present application is a Continuation application of PCT Application No. PCT/CN2023/096184, filed on May 25, 2023, which claims the priority of Chinese Patent Application No. 202310583654.0, filed on May 23, 2023, the entire contents of which are hereby incorporated by reference.

### TECHNICAL FIELD

The application belongs to the technical field of special steel production, and specifically relates to an ultra-high strength (2 GPa) spring steel and a preparation method thereof.

### DESCRIPTION OF THE PRIOR ART

Springs, together with bolts and gears are three basic components of machinery, with a variety of types widely used in industries such as automotive industry, mechanical equipment, light industry, power, aerospace, and rail transit. Playing roles such as buffering, shock absorption, energy storage, connection, support and force transmission in various types of mechanical equipment, the function of springs is extremely important. The good comprehensive performance of springs is the basis for the safe operation of mechanical equipment, and the improvement of spring quality is a prerequisite to ensure the performance of the main engine of mechanical equipment. Springs work under alternating stress, such as periodic bending and torsion, exposed to various forms of tension, compression, torsion, impact, fatigue and corrosion, and sometimes in extremely harsh and complex environments, such as environments with high temperature, low temperature, corrosion and static loads. In recent years, with the rapid development of automobiles and rail transit industries, the demand for spring weight reduction is becoming increasingly urgent in the lightweight design of automobiles and rail transit to save energy and resources, and the need for ultra-high strength springs is growing. However, at present, the strength of spring steel in China is only about 1350 MPa, which seriously restricts the development of new energy vehicles and the weight reduction and emission reduction of various types of vehicles, and cannot meet the development requirements of high-performance and high-speed engines, especially in the fields of aviation and aerospace, etc. The development of high-performance spring steel with ultra-high strength, a great elongation, a high area reduction and good fatigue resistance will be an inevitable trend for high-end equipment components to enhance the independent supporting capabilities and effectively replace imports in China.

In the research and production field of high-performance spring steel, industry giants such as Kobe Steel in Japan lead the global development of spring steel. Spring products are large in scale and have a wide variety in China, but the market share of high-end spring products is very small. That is to say, the industrial structure of spring industry in China has long been in a passive situation of oversupply of low-end ordinary springs and short supply of high-end products (high strength, high stress, special-shaped parts, and special materials). Spring products could no longer fully meet the development needs of high-end equipment manufacturing industry. Suspension springs, valve springs and clutch springs for cars, as well as high-end springs for locomotives, machinery, electric power, military and other industries still need to be imported. In addition, there exists a certain discrepancy in performance between the spring products made in China and similar foreign ones. For example, there are gaps in spring load accuracy, verticality accuracy, and other aspects, which are mainly reflected in unstable performance, large variations of some key quality indicators, and fluctuating service life. The contradiction is even more severe especially when the main engine requires springs to work under high-speed and high-stress conditions.

Spring steel is categorized by chemical composition into non-alloyed spring steel (carbon spring steel) and alloy spring steel. At present, the springs used in various countries are mainly made of high-quality carbon steel with a carbon content of 0.3 to 0.9 wt. % and alloy steel containing Cr—Si, Cr—Mn, Si—Mn, Cr—V and other alloy composition systems. Carbon spring steel is mainly used to make springs such as scroll springs and leaf springs, while most other springs such as suspension springs and valve springs are made of alloy spring steel. Si—Mn spring steel has good elasticity loss resistance and low production cost, becoming the main spring steel production system in China. However, there are certain problems with Si—Mn spring steel, such as the tendency to decarburize during heat treatment and insufficient hardenability, which limit its development. In many other countries than China, Cr—Mn and Cr—V alloy steel are used to prepare spring steels. The reason for this is that the alloy spring steel of these two systems has better hardenability during heat treatment and the surface of the spring steel is not susceptible to decarburize. Based on the above systems, various countries are advancing the development of spring steel with better performance. The main idea is to add Mo, W, V and other alloying elements, to improve the hardenability, refine the grains and reduce the grain size of the spring steel, thereby achieving the purpose of improving the organization and properties of spring steel.

In recent years, with the rapid development of the dual-carbon economy and equipment manufacturing industry, spring products are not only required to achieve better mechanical properties and fatigue properties, but also to have lower production costs. Therefore, the main development directions for spring steel are as follows: firstly, continuing to explore the existing spring steel system to further unleash its potential by using different processes or adding trace elements; and secondly, developing a new spring steel system, which requires a large amount of time and cost and thus gets relatively few research and development efforts in various countries and regions. The strength of SAE9254 and 54SiCrV6 springs, which are currently widely used in the market, is very low, and the production cost of 54SiCrV6 is high. The strength of the UHS2000 spring is higher, but its cost is also high. In view of the pain points and difficulties existing in the industry, the present disclosure provides an ultra-high-strength spring steel micro-alloyed with manganese-aluminum-nitrogen, which has the advantages of a higher mechanical strength, a greater elongation, a higher area reduction, and good fatigue resistance. Furthermore, the preparation method of this ultra-high-strength spring steel is simple and feasible, with low production cost, and it is suitable for industrial production.

### SUMMARY OF THE DISCLOSURE

In view of the current lack of high-strength spring steel products, the present disclosure provides an ultra-high-strength spring steel, which has the advantages of a higher mechanical strength, a greater elongation, a higher area reduction, and good fatigue resistance.

Another objective of the present disclosure is to provide a method for preparing the above ultra-high-strength spring steel, which is simple and easy to implement, and is suitable for industrial production.

To achieve the above objectives, the present disclosure adopts the following technical solutions:
an ultra-high-strength spring steel, which is a manganese-aluminum-nitrogen micro-alloyed spring steel and includes the following chemical components by mass percentage:
main chemical components: C: 0.45 to 0.60%, Si: 0.15 to 0.35%, Mn: 6.0 to 12.0%, Al: 1.0 to 3.0%, Cr: 0.30 to 0.50%, Mo: 0.10 to 0.25%, V: 0.10 to 0.50%, Nb: 0.025 to 0.04%, N: 0.005 to 0.015%;
impurity chemical components: less than or equal to 0.03% of Pb, less than or equal to 0.03% of Sn, less than or equal to 0.03% of Zn, less than or equal to 0.03% of Sb, less than or equal to 0.03% of Bi, less than or equal to 15 ppm of O₂, less than or equal to 15 ppm of H₂, less than or equal to 0.02% of S, less than or equal to 0.02% of P, less than or equal to 0.2% of Cu, less than or equal to 0.35% of Ni; and a balance of iron and unavoidable impurities.

In the present disclosure, addition amount and function of each chemical component are as follows.

Through solid solution strengthening, carbon (C) improves the elastic strength, hardness and wear resistance of the spring steel, but decreases its plasticity, toughness and fatigue strength. When C is controlled within 0.45 to 0.52 wt. % with other alloy elements, an optimal combination with strength, fatigue life, and economic benefits can be obtained. A content of C used in the present disclosure is much less than that of conventional spring steel, which can change structure morphology of martensite and improve the toughness of the spring steel.

Silicon (Si) strengthens ferrite and improves the elasticity of the steel through solid solution, but weakens its plasticity and toughness, and significantly increases the tendency of decarburization and graphitization, resulting in a generation of inclusions and a deterioration of the fatigue performance of the spring. Therefore, in the present disclosure, it is found that the influence on fatigue strength is lowest when a silicon content is controlled within 0.15 to 0.35 wt. %. The content of Si in the present disclosure is smaller than that in conventional spring steel, which decreases the repulsion of carbon, thereby reducing decarburization.

Manganese (Mn) improves the strength of the steel by solid solution and, at the same time, improves the hardenability of the steel, and it can also diminish the repellency of carbon, thereby reducing decarburization. Thus, a content of Mn used in the present disclosure is much higher than that of the conventional spring steel, to improve the dislocation migration ability of the steel by exploiting the interaction of Mn with aluminum and nitrogen, thereby significantly increasing the strength without compromising the toughness of the steel. However, excessive Mn will promote temper brittleness, so it is necessary to control the content of Mn within 6.0 to 12.0 wt. %.

Aluminum (Al) refines grain structure of the steel, inhibits the aging of low-carbon steel, decreases the sensitivity of notches, and especially reduces a ductile-brittle transition temperature of the steel, thereby improving the toughness of the steel at a low temperature. In this disclosure, Al is introduced into the spring steel for the first time. The purpose is to achieve deoxidation, nitrogen fixation, and refinement of grains by using the affinity of Al and N, while also significantly improving the strength, low-temperature toughness, fatigue strength, etc of the steel. However, excess aluminum impacts hot working properties of the steel, and an optimal content of Al is controlled within 1.0 to 3.0 wt. % as determined by tests.

Chromium (Cr) improves the strength, hardenability and tempering stability of the steel through solid solution, which is beneficial for improving the performance and dispersion precipitation of the spring steel. However, a content of Cr used in the present disclosure is much lower than that in conventional spring steel. The purpose is to prevent excessive chromium from easily forming chromium carbide to decrease the plasticity and toughness of the steel. Therefore, the content of Cr is controlled within 0.30 to 0.50 wt. %.

Molybdenum (Mo) improves the strength of the steel by solid solution, greatly improves the hardenability of the steel, and stabilizes carbon elements, which is beneficial to improve the strength of the spring steel. However, excessive Mo may change the quenching curve of the steel and tends to form feathery bainite, which is detrimental to the fatigue strength of the spring steel, so it is required that a content of Mo is controlled to be 0.10 to 0.25 wt. %.

Vanadium (V) and niobium (Nb) form dispersed fine vanadium carbide (VC), niobium carbide (NbC), vanadium nitride (VN) or niobium nitride (NbN) in the steel, which greatly strengthens matrix, and refines grain boundaries at the same time to prevent the growth of grains, Therefore, a fine and high-strength structure can be obtained, which greatly improves the strength and fatigue performance of the spring steel. However, when a single element is excessive, the grains are prone to coarsen and lose their outstanding functions. Therefore, the disclosure utilizes the comprehensive functions of the two elements. After optimization, optimal contents are V: 0.10 to 0.50 wt. % and Nb: 0.025 to 0.04 wt. %.

Cr, Mo, V and Nb are noble elements, which are used in very small amounts in the present disclosure to reduce production costs.

Nitrogen (N) plays a role similar to carbon in the steel, which improves the elasticity, strength and hardness of steel through stronger solid solution strengthening. However, the weakening effect of nitrogen on the plasticity, toughness and fatigue strength of the spring steel is smaller than that of carbon. Especially the martensite formed has a Fe—C—N structure, which has higher fatigue strength. The micro-alloyed spring steel with nitrogen added has higher strength, toughness, and longer fatigue life. An optimal content of N determined in the present disclosure is 50 to 150 ppm.

Sulfur(S), phosphorus (P) and alloying elements form inclusions such as MnS. They not only offset the advantages of the alloying elements, but also cause segregation of S and P, which weakens the toughness of the steel and becomes a source of fatigue cracks, thus seriously reducing the fatigue strength of the spring. Therefore, contents of S and P in spring steel materials should be tightly controlled within 0.02 wt. %.

Copper (Cu) seriously decreases the thermo-plasticity of the material. Due to subsequent hot working, a high content of Cu in the spring is prone to cause micro-cracks, which significantly weakens the strength of the spring. Therefore, a usage amount of Cu should be tightly controlled to be 0.2 wt. % or less.

Nickel (Ni) improves the strength and toughness, reduces a brittle transition temperature, and especially improves the hardenability of the steel. However, due to the high cost of nickel, it is advisable to use other alloys to the extent possible in order to meet performance requirements. Within the range of other element contents, the present disclosure does not necessitate an addition of nickel to meet strength and toughness requirements. A nickel content of equal to or less than 0.35 wt. % is primarily due to the unavoidable introduction of raw materials.

The preparation method of the above ultra-high strength spring steel includes the following steps:
subjecting the spring steel raw material to smelting, refining, RH vacuum degassing, and continuous casting to obtain a steel ingot, and then subjecting the steel ingot to peeling, continuous hot rolling and controlled cooling, to obtain the ultra-high strength spring steel.

In order to reduce costs, the above spring steel raw material may include partially scrap steel. Nonetheless, the scrap steel contains impurities such as copper, therefore, a usage amount of the scrap steel should be controlled within 20% of the total mass of the spring steel raw material.

Specifically, in the preparation process of the ultra-high-strength spring steel, the raw material is placed in a converter, with the mass percentage of the scrap steel in the raw material under control. In order to control the content of the impurities, electromagnetic stirring and RH vacuum degassing are performed throughout the entire process of secondary refining, to make the fiber structure uniform with fewer bubbles, fewer pores, and a denser structure. After the vacuum degassing, the continuous casting is performed to form a stable macrostructure. The continuous hot rolling is performed to ensure a uniform size of the structure. A cooling temperature is controlled to reduce decarburization layers and ensure the shear hardness. A steel product is obtained after cooling to a room temperature.

Further, optimized process parameters in the above process are as follows:

A melting temperature is 1630° C. to 1700° C., and a melting time is 25 to 60 minutes. A refining temperature is 1500° C. to 1550° C. and a refining time is 20 to 60 minutes. Electromagnetic stirring is performed in the refining, to uniform the microstructure and prevent segregation of the alloy elements.

Parameters of the RH vacuum degassing are a vacuum degree of 130 Pa or less, and a vacuum time of 20 to 60 minutes.

A rolling compression ratio of the size of the steel ingot obtained by the continuous casting to the size of the spring steel is greater than 15:1. The cooling of the continuous casting needs to first cool down the temperature to below 1150° C. at 25° C. to 35° C./min, and then naturally cool to the room temperature. This allows the inclusions to be limited on a center line of the steel ingot as much as possible, and reduces the harm to the performance of the product after the steel is rolled.

The steel ingot is peeled with a depth of no less than 3.0 mm.

An initial rolling temperature rolling of the continuous hot rolling is 900° C. to 1000° C., and a final rolling temperature is 780° C. to 900° C. The continuous hot rolling is conducted in an austenite region, to perform the maximum deformation properties of the material and provide favorable conditions for subsequent cooling.

The continuous hot rolling includes rapidly cooling the temperature to 600° C. at a rate of no less than 30° C./min, and then slow cooling to the room temperature at a rate of no more than 10° C./min. In this way, decarburization of surfaces can be avoided and a lower hardness can be maintained to facilitate subsequent shear processing.

The ultra-high-strength spring steel obtained by the above preparation method has a hardness of HB350 or less, a semi-decarburized layer of 0.20 mm or less, without fully decarburized layer.

In order to further improve the performance of the spring steel, the heat treatment is required after processing and forming to obtain finished product. The specific process of the heat treatment includes quenching and tempering. During the heat treatment, the quenching is oil quenching with a quenching temperature of 840 to 890° C. and a holding time which is determined by a coefficient of 1.0 to 1.3 min/mm; and a tempering temperature is 380° C. to 500° C. After the heat treatment, it was found through metallographic examination that the microstructure of the spring steel includes more than 95 volume % sorbite and a small amount of ferrite merely, without other structure.

After the heat treatment, the finished product has a tensile strength of 2000 MPa or more, a yield strength of 1850 MPa or more, an elongation of 7% or more, an area reduction of 25% or more, fatigue cycles greater than 350,000, and a grain size greater than ASTM grade 9.0.

The ultra-high strength spring steel obtained by the above preparation method has an application thickness of 6 to 50 mm or an application diameter of 6 to 35 mm.

The disclosure has the following advantages.

The spring steel provided by the disclosure has a higher mechanical strength, a greater elongation, a higher area reduction and good fatigue resistance, and can be used in high-demand industries such as equipment manufacturing industry, and its cost is lower than that of the currently marketed spring steel. The preparation method provided by the disclosure is scientific, reasonable, simple and easy to implement, and is suitable for large-scale industrial production.

### BRIEF DESCRIPTION OF DRAWINGS

FIG. 1 is a metallographic diagram of spring steel without heat treatment;

FIG. 2 is a metallographic diagram of spring steel of embodiment 1 according to the present disclosure;

FIG. 3 is a metallographic diagram of spring steel of embodiment 2 according to the present disclosure;

FIG. 4 is a metallographic diagram of spring steel of embodiment 3 according to the present disclosure.

### DESCRIPTION OF EMBODIMENTS

The present disclosure will be further described hereinafter in connection with the embodiments and the accompanying drawings, but the present disclosure is not limited by the following embodiments. All raw materials used in the embodiments are commercially available unless otherwise specified.

### Embodiment 1 Preparation of the Ultra-High Strength Spring Steel

The weight percentages of chemical components of the steel in this embodiment were shown in Tab. 1.

The ultra-high strength spring steel was prepared by following steps.

Molten iron was added to a 25-ton converter and smelted at 1680° C. for 45 minutes to obtain steel. Then, 18.0 wt. % scrap steel was added to adjust the temperature to 1650° C., and then together transferred to a refining furnace. Under electromagnetic stirring, alloy materials such as ferrosilicon, ferromanganese, ferrochromium-molybdenum, ferrovanadium, ferroniobium and manganese nitride were added separately. After feeding pure aluminum wire at 1535±15° C. and adjusting the chemical components for 40 minutes, RH vacuum degassing (under a condition of vacuum degree equal to or less than 130 Pa) was performed, and then continuous casting was performed to obtain ingot blanks of 200×200 mm. After cooling to 1150° C. at a rate of 28° C./min, the ingot blanks were air-cooled to a room temperature, and were then peeled. After peeling 3.2 mm in depth, the peeled ingot blanks were heated to 1150° C., and then were continuously rolled to obtain spring steel bars of 24×89 mm with an initial rolling temperature of 1050° C. and a final rolling temperature of 860° C. After rolling, the spring steel bars were quickly cooled to 600° C. at a rate of 37° C./min, and then slowly cooled to the room temperature at a rate of 8° C./min, 24×89 mm steel bars were obtained by the above method. Upon testing, the chemical components of the 24×89 mm steel bars are shown in Tab.1. A microstructure of the spring steel without heat treatment is mainly composed of pearlite and ferrite, as shown in FIG. 1.

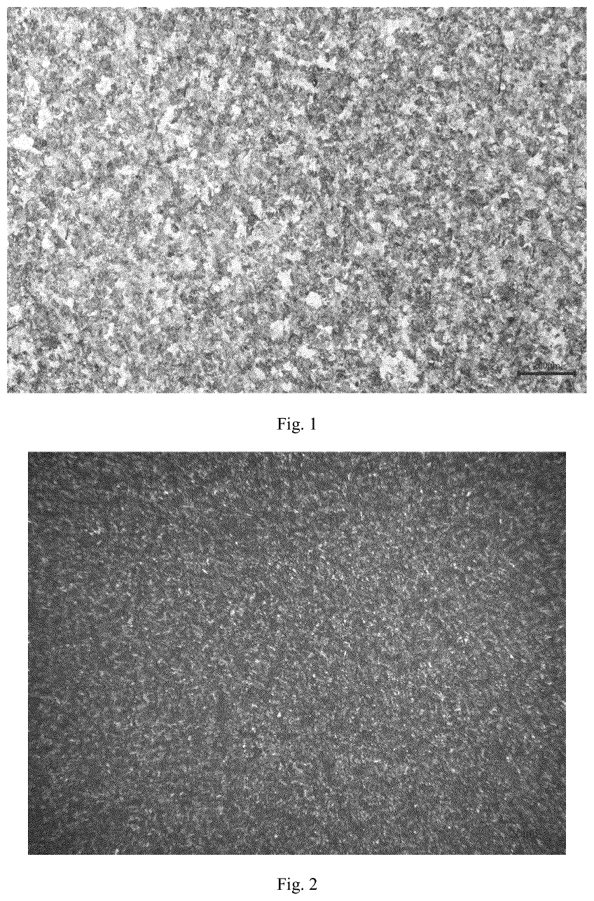

The steel bars obtained in embodiment 1 were further processed into single leaf springs. After being held at 880° C. for 20 minutes, oil quenched and tempered at 460° C. for 45 minutes, leaf spring products were obtained. Sample was taken from the leaf spring products obtained in embodiment 1, and then metallographic specimen was prepared, a metallographic structure of which was shown in FIG. 2. As can be seen from FIG. 2, a microstructure of the spring steel prepared in embodiment 1 contains a uniform sorbite structure and a very small amount of ferrite, with the sorbite structure of more than 95 volume %. Compared with FIG. 1, the microstructure of the spring steel obtained in embodiment 1 was significantly improved. Further, the leaf spring product was subjected to tensile specimen processing and tensile testing in accordance with GB/T228-2002, and the yield strength, elongation and area reduction were tested. An assembled leaf spring was conducted to a fatigue test in accordance with GB/T228-2002, and the test results are shown in Tab. 2. The tensile strength reaches 2193 MPa.

### Embodiment 2 Preparation of the Ultra-High Strength Spring Steel

The weight percentages of chemical components of the steel in this embodiment were shown in Tab. 1.

The ultra-high strength spring steel was prepared by following steps.

Molten iron was added to a 60-ton converter and smelted at 1630° C. for 60 minutes to obtain steel. Then, 15.0 wt. % scrap steel was added to adjust the temperature to 1650° C., and then together transferred to a refining furnace. Under electromagnetic stirring, alloy materials such as ferrosilicon, ferromanganese, ferrochromium-molybdenum, ferrovanadium, ferroniobium and manganese nitride were added separately. After adjusting the chemical components at 1515±15° C. for 60 minutes, vacuum degassing (under a condition of vacuum degree equal to or less than 130 Pa) was performed, and then continuous casting was performed to obtain ingot blanks of 200×200 mm. After cooling to 1150° C. at a rate of 30° C./min, the ingot blanks were air-cooled to the room temperature, and were then peeled. After peeling 3.5 mm in depth, the peeled ingot blanks were heated to 1200° C., and then were continuously rolled to obtain spring steel bars of 24×89 mm, with an initial rolling temperature of 950° C. and a final rolling temperature of 860° C. After rolling, the spring steel bars were quickly cooled to 600° C. at a rate of 35° C./min, and then slowly cooled to the room temperature at a rate of 10° C./min, 24×89 mm steel bars were obtained by the above method. Upon testing, the chemical components of the 24×89 mm steel bars are shown in Tab. 1.

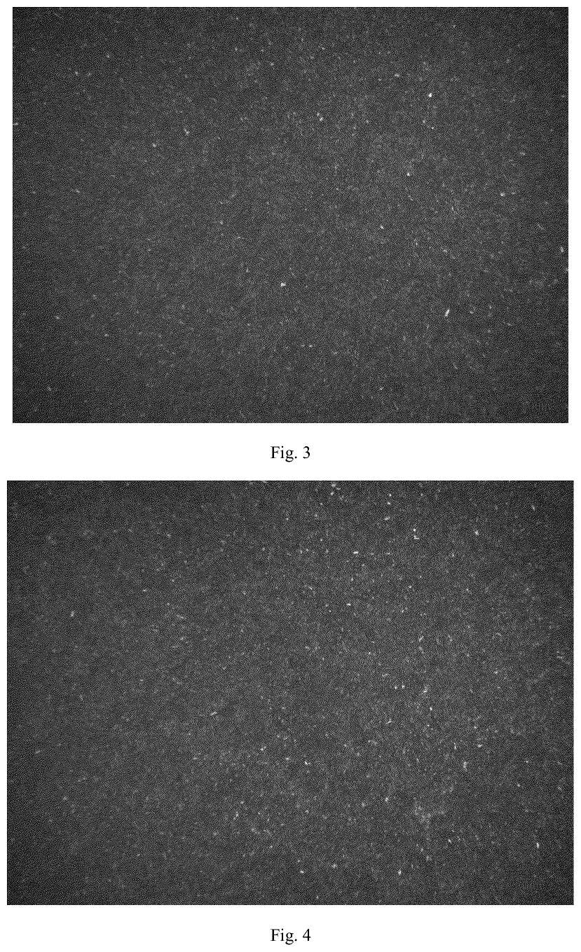

The steel bars obtained in embodiment 2 were further processed into single leaf springs. After being held at 850° C. for 20 minutes, oil quenched and tempered at 480° C. for 45 minutes, leaf spring products were obtained. Sample was taken from the leaf spring products obtained in embodiment 2, and then metallographic specimen was prepared, the metallographic structure of which was shown in FIG. 3. As can be seen from FIG. 3, a microstructure of the spring steel prepared in embodiment 2 contains a uniform sorbite structure and a very small amount of ferrite, with the sorbite structure of more than 95 volume %. Compared with FIG. 1, a microstructure of the spring steel obtained in embodiment 2 was significantly improved. Further, the prepared leaf spring product was subjected to tensile specimen processing and tensile testing in accordance with GB/T228-2002, and the yield strength, elongation and area reduction were tested. An assembled leaf spring was conducted to a fatigue test in accordance with GB/T228-2002, and the test results are shown in Tab. 2. The tensile strength reaches 2183 MPa.

### Example 3 Preparation of the Ultra-High Strength Spring Steel

The weight percentages of chemical components of the steel in this embodiment were shown in Tab. 1.

The ultra-high strength spring steel was prepared by following steps.

Molten iron was added to a 120-ton converter and smelted at 1700° C. for 25 minutes to obtain steel. Then, 16.0 wt. % scrap steel was added to adjust the temperature to 1650° C., and then together transferred to a refining furnace. Under electromagnetic stirring, alloy materials such as ferrosilicon, ferromanganese, ferrochromium-molybdenum, ferrovanadium, ferroniobium and manganese nitride were added separately. After adjusting the chemical components at 1535±15° C. for 30 minutes, vacuum degassing (under a condition of vacuum degree equal to or less than 130 Pa) was performed, and then continuous casting was performed to obtain ingot blanks of 200×200 mm. After cooling to 1150° C. at a rate of 35° C./min, the ingot blanks were air-cooled to the room temperature, and were then peeled. After peeling 3.0 mm in depth, the peeled ingot blanks were heated to 1200° C., and then were continuously rolled to obtain spring steel bars of 24×89 mm, with an initial rolling temperature of 900° C. and a final rolling temperature of 900° C. After rolling, the spring steel bars were quickly cooled to 600° C. at a rate of 40° C./min, and then slowly cooled to the room temperature at a rate of 9° C./min, 24×89 mm steel bars were obtained by the above method. Upon testing, the chemical components of the 24×89 mm steel bars are shown in Tab. 1.

The steel bars obtained in embodiment 3 were further processed into single leaf springs. After being held at 900° C. for 20 minutes, oil quenched and tempered at 500° C. for 45 minutes, leaf spring products were obtained. Sample was taken from the leaf spring products obtained in embodiment 3, and then metallographic specimen was prepared, a metallographic structure of which was shown in FIG. 4. As can be seen from FIG. 4, a microstructure of the spring steel prepared in embodiment 3 contains a uniform sorbite structure and a very small amount of ferrite, with the sorbite structure of more than 95 volume %. Compared with FIG. 1, the microstructure of the spring steel obtained in embodiment 3 was significantly improved. Further, the prepared leaf spring product was subjected to tensile specimen processing and tensile testing in accordance with GB/T228-2002, and the yield strength, elongation and area reduction were tested. An assembled leaf spring was conducted to a fatigue test in accordance with GB/T228-2002, and the test results are shown in Tab. 2. The tensile strength reaches 2156 MPa.

### Control

The chemical components of three common standard steels, such as standard steel SAE9260, standard steel SAE5160 and standard steel SAE6150 are shown in Tab. 1. The above three standard steels were further processed into single leaf springs in accordance with the process of embodiment 3, that is, after being heated at 900° C. for 20 minutes, oil quenched and tempered at 500° C. for 45 minutes, the leaf spring products were obtained. The leaf spring products were subjected to tensile specimen processing and tensile testing in accordance with GB/T228-2002, and the yield strength, elongation and area reduction were tested. Assembled leaf springs were conducted to fatigue tests in accordance with GB/T228-2002. The test results are shown in Tab. 2.

TABLE 1
Comparison of Chemical Components of Different Steel Materials (wt. %)

| Mark | C | Si | Mn | Cr | Mo | Al | V | Nb | N |
|---|---|---|---|---|---|---|---|---|---|
| Embodiment 1 | 0.46 | 0.25 | 7.35 | 0.37 | 0.13 | 1.85 | 0.18 | 0.027 | 0.011 |
| Embodiment 2 | 0.51 | 0.22 | 7.06 | 0.35 | 0.15 | 1.73 | 0.21 | 0.031 | 0.010 |
| Embodiment 3 | 0.49 | 0.27 | 8.03 | 0.39 | 0.12 | 1.79 | 0.22 | 0.027 | 0.009 |
| Standard steel 9260 | 0.62 | 1.81 | 0.79 | 0.13 | 0.012 | 0.02 | <0.01 | ≤0.001 | <0.001 |
| Standard steel 5160 | 0.62 | 0.27 | 0.84 | 0.81 | 0.010 | 0.02 | <0.01 | <0.001 | <0.001 |
| Standard steel 6150 | 0.51 | 0.30 | 0.79 | 0.98 | 0.011 | 0.02 | 0.14 | <0.001 | <0.001 |

TABLE 2
Performance Test Results of Different Finished Products

| | Rp_{0.2} | | | | Average fatigue |
|---|---|---|---|---|---|
| Mark | (MPa) | Rm(MPa) | A(%) | Z(%) | cycles (cycles) |
| Embodiment 1 | 1922 | 2193 | 7.9 | 29 | 381239 |
| Embodiment 2 | 1915 | 2183 | 8.1 | 30 | 392448 |
| Embodiment 3 | 1908 | 2156 | 8.3 | 33 | 408329 |
| Standard steel | 936 | 1087 | 8.3 | 33 | 47274 |
| 9260 | | | | | |
| Standard steel | 987 | 1130 | 8.5 | 32 | 70339 |
| 5160 | | | | | |
| Standard steel | 1039 | 1378 | 8.8 | 34 | 86226 |
| 6150 | | | | | |

As can be seen from the results in Tab. 2, with the plasticity, toughness, area reduction Z, elongation A, etc. maintained at the similar level, the strength of the leaf spring products made of the spring steel of embodiments 1 to 3 had been greatly improved. Compared with standard steel 9260, the yield strength (Rp_{0.2}) of the leaf spring products of the spring steel prepared by the present disclosure was increased by a maximum of about 1.05 times, the tensile strength (Rm) was increased by a maximum of about 1.02 times, and the fatigue strength was increased by more than 4 times. Therefore, the ultra-high-strength spring steel of the present disclosure is especially applicable to the manufacturing and production of weight-saving few leaf springs.

1. An ultra-high strength (2 GPa) spring steel comprising following chemical components in mass ratio:
main chemical components: 0.45 to 0.5% of C, 0.15 to 0.35% of Si, 6.0 to 12.0% of Mn, 1.0-3.0% of Al, 0.30 to 0.50% of Cr, 0.10 to 0.25% of Mo, 0.10 to 0.50% of V, 0.025 to 0.04% of Nb, 0.005 to 0.015% of N;
controlled impurities: less than or equal to 0.03% of Pb, less than or equal to 0.03% of Sn, less than or equal to 0.03% of Zn, less than or equal to 0.03% of Sb, less than or equal to 0.03% of Bi, less than or equal to 15 ppm of O₂, less than or equal to 15 ppm of H₂, less than or equal to 0.02% of S, less than or equal to 0.02% of P, less than or equal to 0.2% of Cu, less than or equal to 0.35% of Ni; and
a balance of iron and unavoidable impurities.

2. A preparation method of the ultra-high strength (2 GPa) spring steel according to claim 1, comprising steps of: sequentially making spring steel raw material be subjected to smelting, refining, RH vacuum degassing, and continuous casting to obtain a steel ingot, and then making the steel ingot be subjected to peeling, continuous hot rolling and controlled cooling, to obtain the ultra-high strength spring steel.

3. The preparation method according to claim 2, wherein a smelting temperature is 1630 to 1700° C. and a smelting time is 25 to 60 minutes; a refining temperature is 1500 to 1550° C. and a refining time is 20 to 60 minutes; and
wherein a vacuum degree of RH vacuum degassing is 130 Pa or less; and a vacuum time is 20 to 60 minutes.

4. The preparation method according to claim 2, wherein electromagnetic stirring is performed during the refining.

5. The preparation method according to claim 2, wherein the continuous casting is performed with cooling which comprises: first reducing a temperature to 1150° C. or less at a rate of 25° C. to 35° C./min, and then naturally reducing to a room temperature;
wherein the cooling is controlled by steps of: rapidly reducing a temperature to 600° C. at a rate of no less than 30° C./min, and then slowly reducing to the room temperature at a rate of no more than 10° C./min; and
wherein an initial rolling temperature of the hot rolling is 900 to 1000° C., and a final rolling temperature is 780 to 900° C.

6. The preparation method according to claim 2, wherein the steel ingot is peeled with a depth of at least 3.0 mm; and a compression ratio of the continuous hot rolling is greater than 15:1.

7. The preparation method according to claim 2, wherein a hardness of the spring steel obtained is HB350 or less, a thickness of semi-decarburized layer is 0.20 mm or less, without fully decarburized layer.

8. The preparation method according to claim 2 further comprising a step of heat treatment; wherein the heat treatment comprising quenching and tempering; the quenching is oil quenching with a quenching temperature of 840 to 890° C. and a holding time which is determined by a coefficient of 1.0 to 1.3 min/mm; and a tempering temperature is 380° C. to 500° C.

9. The preparation method according to claim 8, wherein a microstructure of the spring steel obtained is composed of more than 95 volume % sorbite and a small amount of ferrite structure merely without other structure; and
wherein the spring steel obtained has a tensile strength of 2000 MPa or more, a yield strength of 1850 MPa or more, an elongation of 7% or more, an area reduction of 25% or more, fatigue cycles greater than 350,000, and a grain size greater than ASTM grade 9.0.

10. The preparation method according to claim 8, wherein the spring steel obtained has an application thickness of 6 to 50 mm and an application diameter of 6 to 35 mm.

11. The preparation method according to claim 3, wherein a hardness of the spring steel obtained is HB350 or less, a thickness of semi-decarburized layer is 0.20 mm or less, without fully decarburized layer.

12. The preparation method according to claim 4, wherein a hardness of the spring steel obtained is HB350 or less, a thickness of semi-decarburized layer is 0.20 mm or less, without fully decarburized layer.

13. The preparation method according to claim 5, wherein a hardness of the spring steel obtained is HB350 or less, a thickness of semi-decarburized layer is 0.20 mm or less, without fully decarburized layer.

14. The preparation method according to claim 6, wherein a hardness of the spring steel obtained is HB350 or less, a thickness of semi-decarburized layer is 0.20 mm or less, without fully decarburized layer.
